(19) United States
(12) Patent Application Publication
(10) Pub. No.: US 2010/0128848 A1
(43) Pub. Date: May 27, 2010

(54) X-RAY TUBE HAVING LIQUID LUBRICATED BEARINGS AND LIQUID COOLED TARGET

(75) Inventors: Liangheng Qiu, Waukesha, WI (US); Gregory Alan Lehmann, Brookfield, WI (US); Thomas Dean Scaefer, Brookfield, WI (US); Michael Scott Hebert, Franklin, WI (US); Edwin L. Legall, Menomonee Falls, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/275,936

(22) Filed: Nov. 21, 2008

(51) Int. Cl. H01J 35/12; H01J 35/00

(52) U.S. Cl. 378/133; 378/141

(57) ABSTRACT

An x-ray tube having a liquid lubricated bearing assembly and a liquid cooled anode target. The anode target and bearing assembly having increased lubrication and cooling to withstand higher power, higher temperature and higher load applications.

### BACKGROUND OF THE INVENTION

This disclosure relates generally to x-ray generation systems, and more particularly to an x-ray tube having liquid lubricated bearings and a liquid cooled anode target assembly.

An x-ray tube generally includes a cathode assembly and an anode assembly disposed within a substantially evacuated vacuum vessel. The vacuum vessel is situated within a chamber defined by an outer casing. The outer casing may be lined with lead to shield and prevent any extraneous x-rays from straying from the x-ray tube. The chamber may be filled with a heat absorbing cooling fluid such as, for example, a dielectric oil. During operation of the x-ray tube, the cooling fluid is circulated through the chamber by a pump. The circulating cooling fluid absorbs heat from the vacuum vessel and other components of the x-ray tube, preventing damage thereto. The vacuum vessel is constructed to endure very high temperatures.

The cathode assembly is positioned at some distance from the anode assembly, and a voltage difference is maintained therebetween in order to extract and accelerate electrons from the cathode assembly towards the anode assembly. This voltage differential generates an electric field gradient having a strength defined by the voltage differential between the anode assembly and cathode assembly divided by the distance therebetween.

The anode assembly typically includes a cylindrical rotor built into a cantilevered shaft that supports a rotatable anode target. A stator coupled to a motor surrounds the rotor and causes rotation of the anode target via the rotor. A seal assembly seals the anode target within the vacuum vessel to substantially keep the vacuum vessel hermetically sealed. The anode target is typically mounted on a bearing assembly that allows rotation of the anode target by the motor. The bearing assembly typically includes ball bearings positioned within raceways. A dry metal lubricant or a liquid metal lubricant may be used on the ball bearings to increase the life of the bearings. The anode target includes a target track that is generally fabricated from a refractory metal with a high atomic number, such as tungsten, molybdenum, niobium, tantalum, rhenium, or alloys thereof. The cathode assembly typically includes a cathode emitter situated opposite the anode target within the vacuum vessel that emits electrons in the form of an electron beam that are accelerated toward the anode target and impact the target track of the anode target at a high velocity. As the electrons impact the target, the kinetic energy of the electrons is converted to high-energy electromagnetic radiation, or x-rays. The x-rays are directed out of the x-ray tube through an x-ray transmissive window in the x-ray tube housing. The x-rays are then transmitted through an object being imaged and intercepted by a detector that forms an image of the object's internal anatomy, contents or structure.

The impact of electrons on the target track of the anode target produces a significant amount of thermal energy that typically results in very high temperatures within the vacuum vessel of the x-ray tube. Because of these high temperatures, the anode target is typically rotated at a high rotational speed. In addition, the anode target and bearing assembly must have sufficient heat dissipation capability.

Current anode targets without direct cooling have the limitation of dissipating enough heat under higher power applications. Future imaging systems may require an x-ray tube with higher power capabilities. These higher power applications will likely create even higher temperatures within the vacuum vessel of the x-ray tube. It may be difficult for current anode targets to be used for higher power applications since the target track of the anode target may crack or melt under higher temperatures.

Future imaging systems may also require an x-ray tube with higher load capabilities. A higher load capability will increase stress on the bearing assembly. Current bearing assemblies are typically lubricated with a dry metal lubricant or a liquid metal lubricant. These lubricants may provide insufficient lubrication and insufficient cooling of the bearing assembly and anode target, and thereby may limit the life of the anode target and bearing assembly under higher power and higher load applications.

Therefore, there is a need for a system and method that provides the anode target and bearing assembly of an x-ray tube with increased lubrication and cooling to withstand higher power, higher temperature and higher load applications.

### BRIEF DESCRIPTION OF THE INVENTION

In accordance with an aspect of the disclosure, an x-ray tube comprising a liquid cooled anode target; and a liquid lubricated bearing assembly.

In accordance with an aspect of the disclosure, an x-ray tube comprising at least one vacuum vessel forming a substantially evacuated vacuum chamber; an anode assembly disposed at least partially within the vacuum chamber; a cathode assembly disposed at least partially within the vacuum chamber and spaced apart from the anode assembly; the anode assembly comprising a rotatable anode target mounted to a rotatable bearing assembly housing; an end cap coupled around a first end of the rotatable bearing assembly housing, the end cap forming a closed end at the first end of the rotatable bearing assembly housing; a stationary shaft; and at least one bearing assembly coupled between an outer surface of the stationary shaft and an inner surface of the rotatable bearing assembly housing; the x-ray tube further comprising at least one ferrofluidic seal coupled to an outer surface on a second end of the rotatable bearing assembly housing for sealing the rotatable bearing assembly housing within the vacuum chamber; at least one opening extending through the stationary shaft; a gap formed between the outer surface of the stationary shaft and the inner surface of the rotatable bearing assembly housing; and a flow path for circulating a liquid coolant and lubricant through the at least one opening, the gap, and the at least one bearing assembly.

In accordance with an aspect of the disclosure, an x-ray tube anode assembly comprising a stationary shaft; at least one bearing assembly coupled around the stationary shaft; a rotatable bearing assembly housing coupled around the at least one bearing assembly; a rotatable anode target mounted to the rotatable bearing assembly housing; an end cap coupled around a first end of the bearing assembly housing forming a closed end thereof; a second end of the rotatable bearing assembly housing coupled to a drive assembly for rotating the rotatable bearing assembly housing and the rotatable anode target; at least one ferrofluidic seal coupled to the second end of the rotatable bearing assembly housing; at least one opening extending through the stationary shaft; a gap formed between the stationary shaft, the end cap and the rotatable bearing assembly housing; a flow path for circulating a liquid coolant and lubricant through the at least one opening, the gap, and the at least one bearing assembly.

In accordance with an aspect of the disclosure, an x-ray tube anode assembly comprising a stationary shaft; at least one bearing assembly coupled around the stationary shaft; a rotatable bearing assembly housing coupled around the at least one bearing assembly; a rotatable anode target mounted to the rotatable bearing assembly housing; an open end member coupled around a first end of the bearing assembly housing; a second end of the rotatable bearing assembly housing coupled to a drive assembly for rotating the rotatable bearing assembly housing, the rotatable anode target, and the open end member; a first ferrofluidic seal coupled to the second end of the rotatable bearing assembly housing; a second ferrofluidic seal coupled to the open end member; a gap formed between the stationary shaft and the rotatable bearing assembly housing and the open end member; a flow path for circulating a liquid coolant and lubricant through the gap and the at least one bearing assembly.

Various other features, aspects, and advantages will be made apparent to those skilled in the art from the accompanying drawings and detailed description thereof.

### BRIEF DESCRIPTION OF THE DRAWINGS

FIG. 1 is a block diagram of an exemplary embodiment of an x-ray imaging system;

FIG. 2 is a cross-sectional schematic diagram of an exemplary embodiment of a portion of an x-ray tube;

FIG. 3 is a cross-sectional schematic diagram of an exemplary embodiment of a portion of an x-ray tube;

FIG. 4 is a cross-sectional schematic diagram of an exemplary embodiment of a portion of an x-ray tube;

FIG. 5 is a cross-sectional schematic diagram of an exemplary embodiment of a portion of an x-ray tube;

FIG. 6 is a cross-sectional schematic diagram of an exemplary embodiment of a portion of an x-ray tube; and

FIG. 7 is a cross-sectional schematic diagram of an exemplary embodiment of a portion of an x-ray tube.

### DETAILED DESCRIPTION OF THE INVENTION

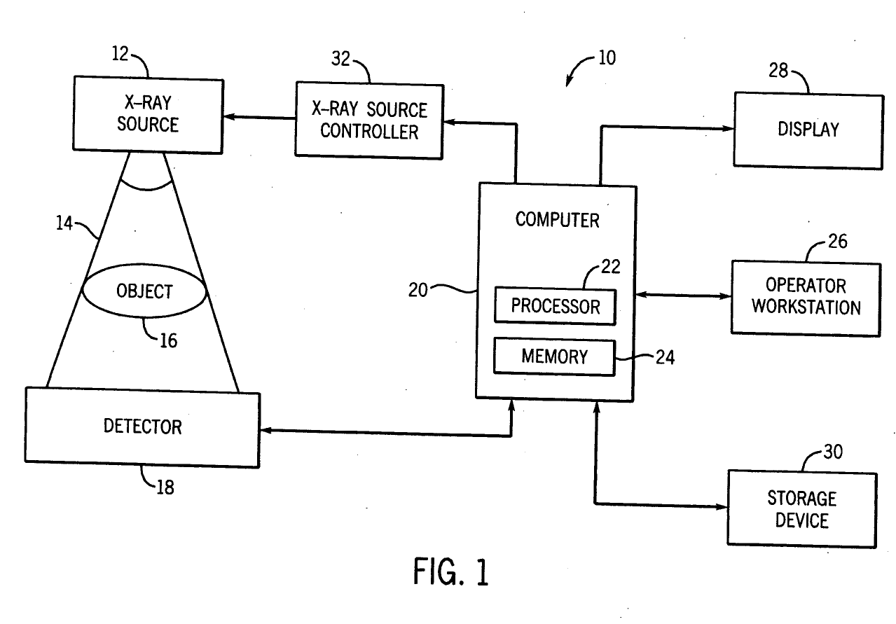

Referring now to the drawings, FIG. 1 illustrates a block diagram of an exemplary embodiment of an x-ray imaging system 10 designed both to acquire original image data and to process the image data for display and/or analysis. It will be appreciated by those skilled in the art that this disclosure is applicable to different types of x-ray imaging systems implementing an x-ray tube, such as radiography, mammography, and vascular imaging systems. Other imaging systems such as computed tomography (CT) systems and digital radiography (RAD) systems may also benefit from this disclosure. The following discussion of x-ray imaging system 10 is merely an example of one such implementation and is not intended to be limiting in terms of modality.

As shown in FIG. 1, x-ray imaging system 10 includes an x-ray source 12 configured to project a beam of x-rays 14 through an object 16 and towards a detector 18. Object 16 may include human beings, animals, pieces of baggage, or other objects desired to be scanned. X-ray source 12 may include a conventional x-ray tube producing x-ray photons possessing a wide energy spectrum. The x-ray beam 14 generated by x-ray source 12 passes through object 16 and, after being attenuated by object 16, impinges upon detector 18. The detector 18 converts x-ray photons received on its surface to lower energy photons, and subsequently to electrical signals that represent the intensity of the impinging x-ray beam, and hence the attenuated x-ray beam, as it passes through object 16. The electrical signals are transmitted to a computer 20.

The computer 20, including at least one processor 22 and associated memory 24, receives the electrical signals from detector 18 and generates images corresponding to the internal anatomy, contents, or structure of the object 16 being imaged. The at least one processor 22 may carry out various functionality in accordance with routines stored in the associated memory 24. The associated memory 24 may also serve to store configuration parameters, operational logs, raw and/or processed image data, and so forth.

The computer 20 may be coupled to a range of external devices via a communications interface. The computer 20 communicates with an operator workstation 26 to enable an operator (not shown), using operator workstation 26, to control the imaging parameters and to view the acquired images. The operator workstation 26 includes some form of operator interface, such as a keyboard, mouse, joystick, touch enabled device, voice activated controller, or any other suitable input device (not shown) that allows an operator to control the x-ray imaging system 10 and view reconstructed images or other data from computer 20 on a display 28. Additionally, operator workstation 26 allows an operator to store acquired images in at least one storage device 30, which may include hard drives, tape drives, floppy discs, compact discs (CDs), digital versatile discs (DVDs), flash memory storage devices, universal serial bus (USB) storage devices, FireWire® storage devices, network storage devices, etc. The operator may also use workstation 26 to provide commands and instructions to computer 20 for controlling operation of an x-ray source controller 32 that provides power and timing signals to x-ray source 12. The computer 20 is coupled to x-ray source controller 32, which in turn is coupled to x-ray source 12 for controlling operation of x-ray source 12.

The x-ray tube within x-ray source 12 of x-ray imaging system 10 includes a multilayer assembly providing high x-ray radiation shielding, high backscattered electron absorption, high temperature operation, and high durability.

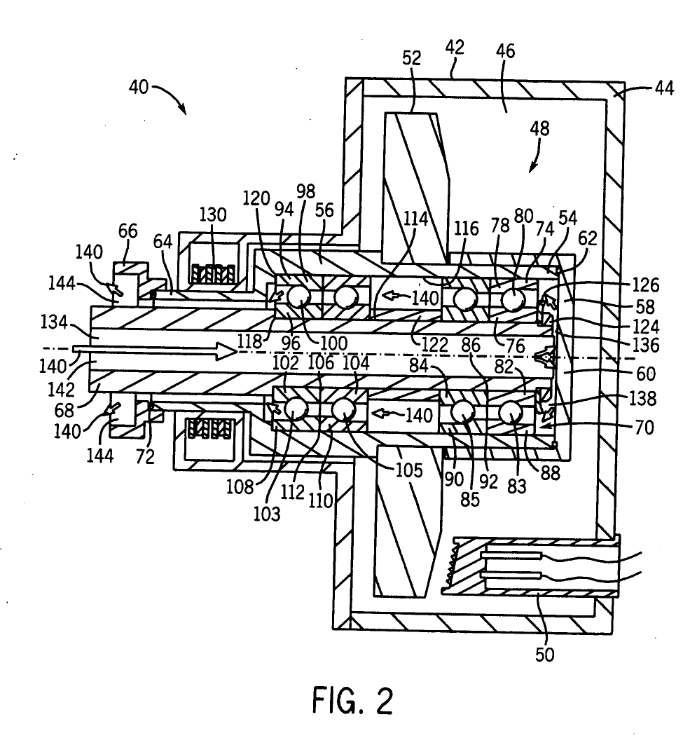

In a typical vacuum environment, an anode target usually has very poor heat dissipation capability, and a bearing assembly has very poor reliability. This disclosure provides various embodiments as shown in FIGS. 2-7 for new anode assembly designs where the anode target is cooled with a liquid and the bearings of a bearing assembly are lubricated with the same liquid to improve reliability of the anode target and bearing assembly. In an exemplary embodiment, the liquid functions as a liquid coolant and lubricant. The liquid lubricated bearings and liquid cooled anode target ensure that a bearing assembly has a long life and high load capability, and an anode target is able to dissipate more heat. This increases the x-ray tube capacity for higher power, higher loads and increases the life of the x-ray tube.

FIG. 2 illustrates a cross-sectional schematic diagram of an exemplary embodiment of a portion of an x-ray tube, typically called an x-ray tube insert 40. The x-ray tube insert 40 includes at least one vacuum vessel 42 having a frame 44 and forming a substantially evacuated vacuum chamber 46 therein. The at least one vacuum vessel 42 is constructed to endure very high temperatures and includes an anode assembly 48 and a cathode assembly 50, which are at least partially disposed therein. The anode assembly 48 includes a rotatable anode target 52 mounted to a first end 54 of a rotatable bearing assembly housing 56. The anode assembly 48 also includes an end cap 58 coupled around the first end 54 of the bearing assembly housing 56 forming a closed end 60 thereof. In an exemplary embodiment, the end cap 58 may be a bolted, brazed, screwed, soldered, welded, or otherwise mechanically attached to the first end 54 of the bearing assembly housing 56. In an exemplary embodiment, a first sealing element 62 hermetically seals the end cap 58 to the first end 54 of the bearing assembly housing 56. A second end 64, opposite the first end 54, of the rotatable bearing assembly housing 56 is coupled to a drive assembly 66 for rotating the rotatable bearing assembly housing 56 and in turn rotating the rotatable anode target 52 at a very high angular velocity. The rotatable bearing assembly housing 56 and anode target 52 attached thereto rotate around a stationary shaft 68 through the use of at least one bearing assembly 70 surrounding the stationary shaft 68. In an exemplary embodiment, a second sealing element 72 hermetically seals the second end 64 of the rotatable bearing assembly housing 56 to the drive assembly 66.

In an exemplary embodiment, the at least one bearing assembly 70 includes a first bearing assembly 74 and a second bearing assembly 94. In an exemplary embodiment, the first bearing assembly 74 is positioned between an outer surface 114 of the stationary shaft 68 and an inner surface 116 of the bearing assembly housing 56. In an exemplary embodiment, the second bearing assembly 94 is also positioned between the outer surface 114 of the stationary shaft 68 and the inner surface 116 of the bearing assembly housing 56 remote from the first bearing assembly 74.

In an exemplary embodiment, a first groove 118 may be formed in the outer surface 114 of the shaft 68 near the first end 54 and a corresponding second groove 120 may be formed in the inner surface 116 of the bearing assembly housing 56 to hold the at least one bearing assembly 70 therein. In an exemplary embodiment, a spacer element 122 may be positioned around the shaft 68 between the first bearing assembly 74 and the second bearing assembly 94. A fastener 124 may be located at the end of the shaft 68 and positioned against the first bearing assembly 74 to hold the at least one bearing assembly 70 in place. In an exemplary embodiment, a washer 126 may be positioned between the at least one bearing assembly 70 and the fastener 124. In an exemplary embodiment, the fastener 124 may be a bolted, brazed, screwed, soldered, welded, or otherwise mechanically attached to the end of the shaft 68.

In an exemplary embodiment, the first bearing assembly 74 is a duplex bearing assembly. The first bearing assembly 74 includes a stationary inner race 76 and a rotatable outer race 78 with at least one bearing element 80 positioned between the stationary inner race 76 and the rotatable outer race 78. Although the stationary inner race 76 and the rotatable outer race 78 are shown in FIG. 2 as multi-race elements, the stationary inner race 76 and the rotatable outer race 78 may be formed as single race elements.

The stationary inner race 76 is positioned adjacent to the outer surface 114 of the stationary shaft 68. The inner race 76 is comprised of a first inner race element 82 and a second inner race element 84. These two inner race elements 82, 84 preferably do not contact each other such that an axial gap 86 is formed therebetween. The rotatable outer race 78 is positioned adjacent to the inner surface 116 of the bearing assembly housing 56. The outer race 78 is comprised of a first outer race element 88 and a second outer race element 90. These two outer race elements 88, 90 preferably do not contact each other such that an axial gap 92 is formed therebetween. A first at least one bearing element 83 is positioned between the first inner race element 82 and the first outer race element 88. A second at least one bearing element 85 is positioned between the second inner race element 84 and the second outer race element 90.

In an exemplary embodiment, the second bearing assembly 94 is a duplex bearing assembly. The second bearing assembly 94 includes a stationary inner race 96 and a rotatable outer race 98 with at least one bearing element 100 positioned between the stationary inner race 96 and the rotatable outer race 98. Although the stationary inner race 96 and the rotatable outer race 98 are shown in FIG. 2 as multi-race elements, the stationary inner race 96 and the rotatable outer race 98 may be formed as single race elements.

The stationary inner race 96 is positioned adjacent to the outer surface 114 of the stationary shaft 68. The inner race 96 is comprised of a first inner race element 102 and a second inner race element 104. These two inner race elements 102, 104 preferably do not contact each other such that an axial gap 106 is formed therebetween. The rotatable outer race 98 is positioned adjacent to the inner surface 116 of the bearing assembly housing 56. The outer race 98 is comprised of a first outer race element 108 and a second outer race element 110. These two outer race elements 108, 110 preferably do not contact each other such that an axial gap 112 is formed therebetween. A first at least one bearing element 103 is positioned between the first inner race element 102 and the first outer race element 108. A second at least one bearing element 105 is positioned between the second inner race element 104 and the second outer race element 110.

During operation of the x-ray tube, the vacuum vessel frame 44 and the shaft 68 are stationary, while the bearing assembly housing 56, end cap 58 and anode target 52 rotate around the stationary shaft 68.

The anode target 52 is sealed within the vacuum chamber 46 of the vacuum vessel frame 44 by a ferrofluidic seal 130. A ferrofluidic seal generally includes a magnet and two pole pieces. Typically, the magnet is an annular, or hollow cylindrical, permanent type magnet that is axially polarized. Per convention, the magnet is positioned about a housing so as to encircle the housing without physically touching the housing. The two pole pieces, in turn, are typically annular as well and generally comprise magnetically permeable material. As such, the two pole pieces sandwich (i.e., abut) the magnet at the magnet's two pole ends so that the inner surfaces of the annular-shaped pole pieces respectively both face and encircle the outer surface of the housing, thereby forming (i.e., defining) a close-proximity annular-shaped gap about the housing. In such a configuration, the magnet is able to establish a desired magnetic flux path both in and about the housing for thereby concentrating and retaining ferrofluid in a seal-tight manner in the annular gap about the housing. The ferrofluidic seal 130 is positioned outside of the vacuum chamber 46 between the vacuum vessel frame 44 and the bearing assembly housing 56 to seal the anode assembly 48 within the vacuum chamber 46. The ferrofluidic seal 130 encircles the bearing assembly housing 56 forming a hermetic seal around the bearing assembly housing 56 to maintain a vacuum within the vacuum chamber 46. The ferrofluidic seal 130 serves as a barrier to the passage of gas along an outer surface 132 of the bearing assembly housing 56 at the second end 64 thereof, while at the same time permitting rotation of the bearing assembly housing 56 as desired.

The stationary shaft 68 includes at least one opening 134 extending therethrough creating a hollow shaft. In addition, a gap 136 is formed between the stationary shaft 68, end cap 58 and bearing assembly housing 56 extending through the at least one bearing assembly 70. The at least one opening 134 and gap 136 provides a path 138 as shown by arrows 140 for a liquid coolant and lubricant to flow. The liquid coolant and lubricant enters the anode assembly 48 through an inlet 142 in the opening 134 extending through shaft 68, flows around the outside of the shaft 68 and inside of the bearing assembly housing 56 through the at least one bearing assembly 70, and exits through an outlet 144 in the gap 136 between the shaft 68 and the bearing assembly housing 56 to cool the anode target 52 and lubricate and cool the at least one bearing assembly 70. In an exemplary embodiment, the liquid coolant and lubricant may be circulated through the at least one opening 134 and gap 136 between the shaft 68 and the bearing assembly housing 56 through the at least one bearing assembly 70 by a pump (not shown). In an exemplary embodiment, the inlet 142 and the outlet 144 may be coupled to a reservoir of liquid coolant and lubricant and coupled to the pump for circulating the liquid coolant and lubricant through the flow path 138.

The liquid coolant and lubricant functions both as a coolant for cooling the anode target and as a lubricant and coolant for lubricating and cooling the at least one bearing assembly 70. In an exemplary embodiment, the liquid coolant and lubricant may be a dielectric oil. In an exemplary embodiment, the liquid coolant and lubricant may be a bearing oil lubricant, such as a mineral oil or a synthetic oil.

In an exemplary embodiment, the at least one bearing assembly 70 may include duplex bearings, angular contact bearings, tapped roller bearings, or needle bearings.

In an exemplary embodiment, the flow path 138 direction of the liquid coolant and lubricant as indicated by arrows 140 in FIG. 2 may be reversed.

In an exemplary embodiment, the anode target 52 may be hollow, allowing the liquid coolant and lubricant to flow through the anode target 52.

This x-ray tube insert design allows the anode target to handle much higher heat and power without having to change the anode target material. Hence this design provides a higher power anode target without the use of new anode target materials.

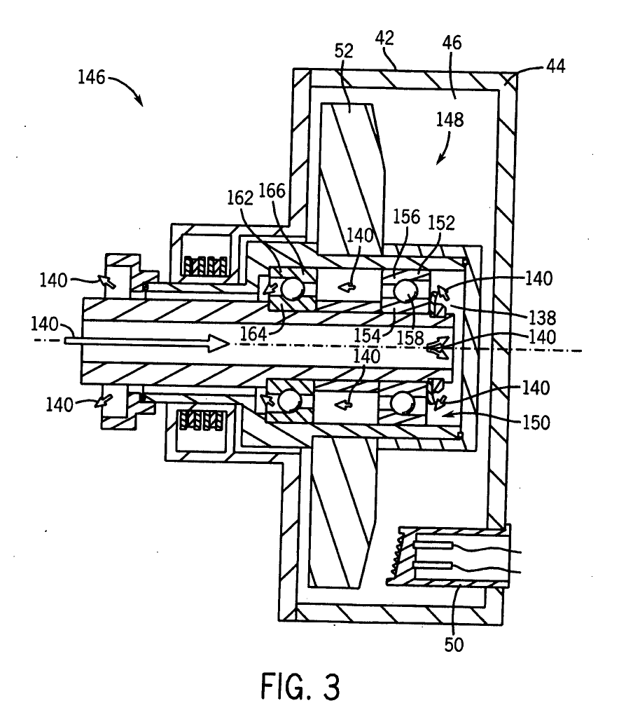

FIG. 3 illustrates a cross-sectional schematic diagram of an exemplary embodiment of an x-ray tube insert 146. The x-ray tube insert 146 includes at least one vacuum vessel 42 having a frame 44 and forming a substantially evacuated vacuum chamber 46 therein. The at least one vacuum vessel 42 is constructed to endure very high temperatures and includes an anode assembly 148 and a cathode assembly 50, which are at least partially disposed therein. The only difference between the x-ray tube insert 146 shown in FIG. 3 from the x-ray tube insert 40 shown in FIG. 2 is the configuration of the at least one bearing assembly 150 within the anode assembly 148. The anode assembly 148 shown in FIG. 3 includes one pair of angular contact bearings, while the anode assembly 48 shown in FIG. 2 includes two pairs of duplex bearings.

The at least one bearing assembly 150 includes a first bearing assembly 152 and a second bearing assembly 162. The first bearing assembly 152 includes a stationary inner race 154 and a rotatable outer race 156 with at least one bearing element 158 positioned between the stationary inner race 154 and the rotatable outer race 156. The second bearing assembly 162 includes a stationary inner race 164 and a rotatable outer race 166 with at least one bearing element 168 positioned between the stationary inner race 164 and the rotatable outer race 166.

In an exemplary embodiment, the first and second bearing assemblies 152, 162 may be tapped roller bearings or needle bearings.

In an exemplary embodiment, the flow path 138 direction of the liquid coolant and lubricant as indicated by arrows 140 in FIG. 3 may be reversed.

In an exemplary embodiment, the anode target 52 may be hollow, allowing the liquid coolant and lubricant to flow through the anode target 52.

This x-ray tube insert design allows the anode target to handle much higher heat and power without having to change the anode target material. Hence this design provides a higher power anode target without the use of new anode target materials.

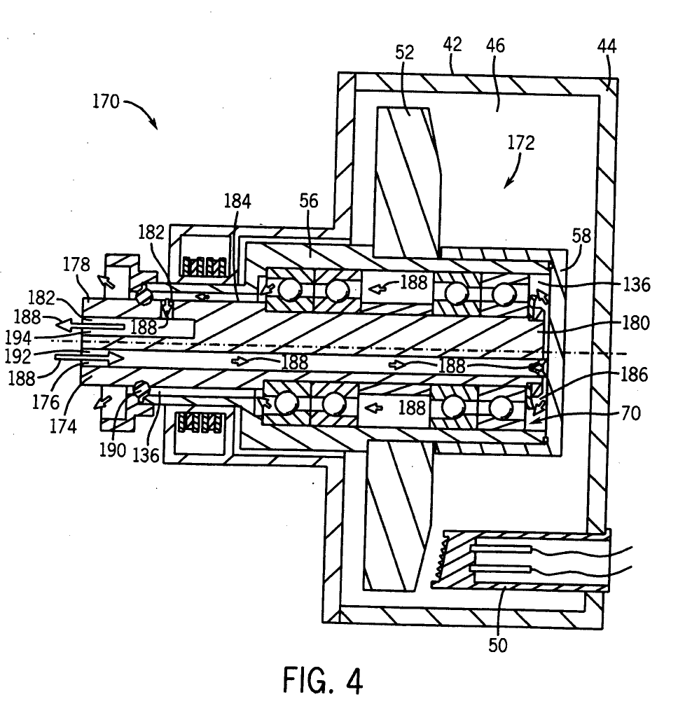

FIG. 4 illustrates a cross-sectional schematic diagram of an exemplary embodiment of an x-ray tube insert 170. The x-ray tube insert 170 includes at least vacuum vessel 42 having a frame 44 and forming a substantially evacuated vacuum chamber 46 therein. The at least one vacuum vessel 42 is constructed to endure very high temperatures and includes an anode assembly 172 and a cathode assembly 50, which are at least partially disposed therein. The only difference between the x-ray tube insert 170 shown in FIG. 4 from the x-ray tube insert 40 shown in FIG. 2 is the configuration of the anode assembly 172. The anode assembly 172 shown in FIG. 4 includes a stationary shaft 174 having a first opening 176 extending through the length of the shaft 174 from a first end 178 to a second end 180, the second end 180 being opposite the first end 178, and a second opening 182 extending from a sidewall 184 of the shaft 174 through the first end 178 of the shaft. The first and second openings 176, 182 through the shaft 174 and the gap 136 formed between the stationary shaft 174, end cap 58 and bearing assembly housing 56 extending through the at least one bearing assembly 70 provide a path 186 as shown by arrows 188 for a liquid coolant and lubricant to flow. A sealing element 190, such as an o-ring, is used to hermetically seal the gap 136 between the bearing assembly housing 56 and the stationary shaft 174 at the second end 64 of the rotatable bearing assembly housing 56.

The liquid coolant and lubricant enters the anode assembly 172 through an inlet 192 in the first opening 176 extending through shaft 174, flows around the outside of the shaft 174 and inside of the bearing assembly housing 56 through the at least one bearing assembly 70, in the second opening 182 in the sidewall 184 of the shaft 174, and exits through an outlet 194 in the first end 178 of the shaft 174 to cool the anode target 52 and lubricate and cool the at least one bearing assembly 70. In an exemplary embodiment, both the inlet 192 and the outlet 194 are through the first end 178 in the shaft 174.

In an exemplary embodiment, the at least one bearing assembly 70 may include duplex bearings, angular contact bearings, tapped roller bearings, or needle bearings.

In an exemplary embodiment, the flow path 186 direction of the liquid coolant and lubricant as indicated by arrows 188 in FIG. 4 may be reversed.

In an exemplary embodiment, the anode target 52 may be hollow, allowing the liquid coolant and lubricant to flow through the anode target 52.

This x-ray tube insert design allows the anode target to handle much higher heat and power without having to change the anode target material. Hence this design provides a higher power anode target without the use of new anode target materials.

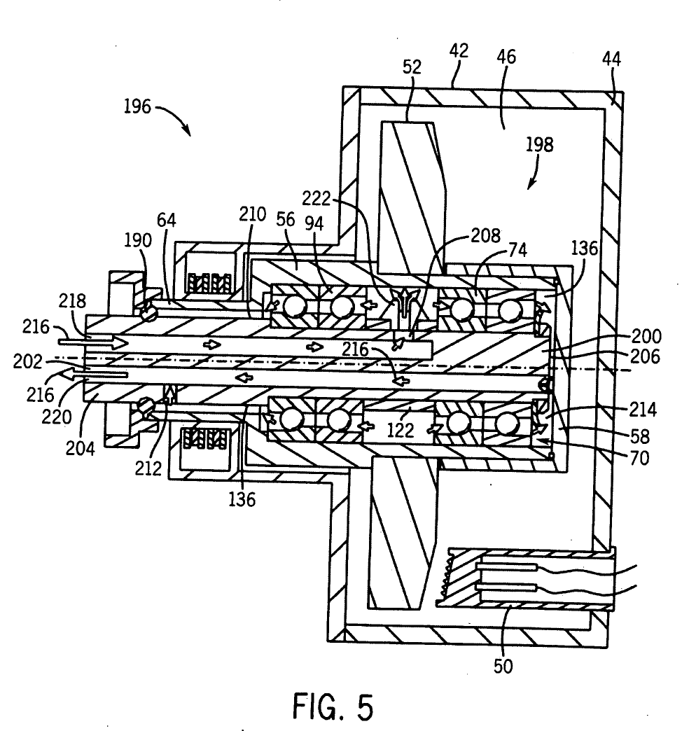

FIG. 5 illustrates a cross-sectional schematic diagram of an exemplary embodiment of an x-ray tube insert 196. The x-ray tube insert 196 includes at least one vacuum vessel 42 having a frame 44 and forming a substantially evacuated vacuum chamber 46 therein. The at least one vacuum vessel 42 is constructed to endure very high temperatures and includes an anode assembly 198 and a cathode assembly 50, which are at least partially disposed therein. The only difference between the x-ray tube insert 196 shown in FIG. 5 from the x-ray tube insert 170 shown in FIG. 4 is the configuration of the anode assembly 198. The anode assembly 198 shown in FIG. 5 includes a stationary shaft 200 having a first opening 202 extending through the length of the shaft 200 from a first end 204 to a second end 206, the second end 206 being opposite the first end 204, a second opening 208 extending from a sidewall 210 of the shaft 200 through the first end 204 of the shaft, and a third opening 212 extending from the sidewall 210 of the shaft 200 to the first opening 202 extending through the first and second ends 204, 206 of the shaft. The anode assembly 198 further includes a nozzle 222 coupled to the second opening 208 and extending through the spacer element 122 between the first bearing assembly 74 and the second bearing assembly 94 for cooling the anode target 52. In an exemplary embodiment, the nozzle 222 may be a jet spray nozzle.

The first, second and third openings 202, 208, 212 through the shaft 200, and the gap 136 formed between the stationary shaft 200, end cap 58 and bearing assembly housing 56 extending through the at least one bearing assembly 70 provide a path 214 as shown by arrows 216 for a liquid coolant and lubricant to flow. A sealing element 190, such as an o-ring, is used to hermetically seal the gap 136 between the bearing assembly housing 56 and the stationary shaft 200 at the second end 64 of the rotatable bearing assembly housing 56.

The liquid coolant and lubricant enters the anode assembly 198 through an inlet 218 in the first end 204 of the shaft 200 through the second opening 208, flows through the nozzle 222, flows around the outside of the shaft 200 and inside of the bearing assembly housing 56 through the at least one bearing assembly 70, through the first and third openings 202, 212, and exits through an outlet 220 in first opening 202 in the first end 204 of the shaft 200 to cool the anode target 52 and lubricate and cool the at least one bearing assembly 70. In an exemplary embodiment, both the inlet 218 and the outlet 220 are through the first end 204 in the shaft 200.

In an exemplary embodiment, the at least one bearing assembly 70 may include duplex bearings, angular contact bearings, tapped roller bearings, or needle bearings.

In an exemplary embodiment, the flow path 214 direction of the liquid coolant and lubricant as indicated by arrows 216 in FIG. 5 may be reversed.

In an exemplary embodiment, the anode target 52 may be hollow, allowing the liquid coolant and lubricant to flow through the anode target 52.

This x-ray tube insert design allows the anode target to handle much higher heat and power without having to change the anode target material. Hence this design provides a higher power anode target without the use of new anode target materials.

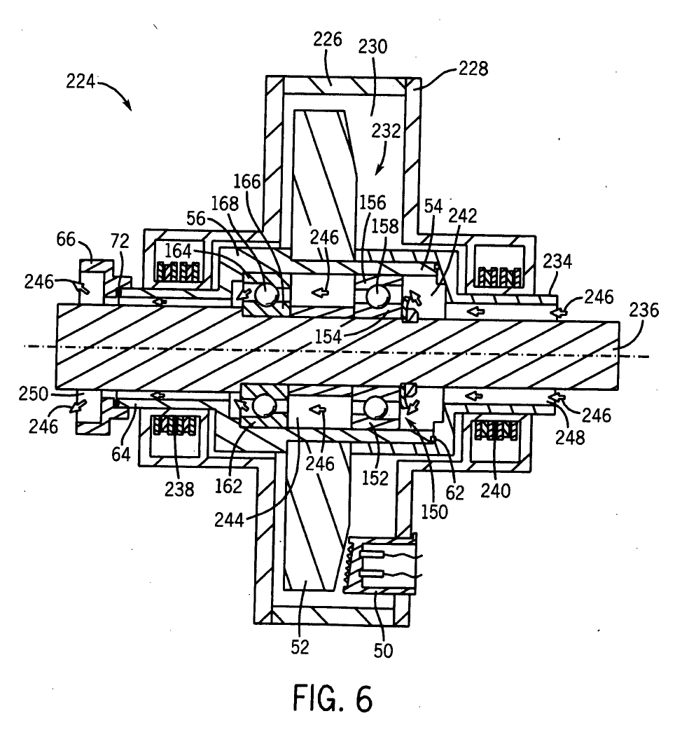

FIG. 6 illustrates a cross-sectional schematic diagram of an exemplary embodiment of an x-ray tube insert 224. The x-ray tube insert 224 includes at least one vacuum vessel 226 having a frame 228 and forming a substantially evacuated vacuum chamber 230 therein. The at least one vacuum vessel 226 is constructed to endure very high temperatures and includes an anode assembly 232 and a cathode assembly 50, which are at least partially disposed therein. The anode assembly 232 includes a rotatable anode target 52 mounted to a first end 54 of a rotatable bearing assembly housing 56. The anode assembly 232 also includes an open end member 234 coupled around the first end 54 of the bearing assembly housing 56. In an exemplary embodiment, the open end member 234 may be a bolted, brazed, screwed, soldered, welded, or otherwise mechanically attached to the first end 54 of the bearing assembly housing 56. In an exemplary embodiment, a first sealing element 62 hermetically seals the open end member 234 to the first end 54 of the bearing assembly housing 56. A second end 64, opposite the first end 54, of the rotatable bearing assembly housing 56 is coupled to a drive assembly 66 for rotating the rotatable bearing assembly housing 56 and in turn rotating the rotatable anode target 52 at a very high angular velocity. The rotatable bearing assembly housing 56 and anode target 52 attached thereto rotate around a stationary shaft 236 through the use of at least one bearing assembly 150 surrounding the stationary shaft 236. In an exemplary embodiment, the stationary shaft 236 is a solid shaft. In an exemplary embodiment, a second sealing element 72 hermetically seals the second end 64 of the rotatable bearing assembly housing 56 to the drive assembly 66.

The at least one bearing assembly 150 includes a first bearing assembly 152 and a second bearing assembly 162. The first bearing assembly 152 includes a stationary inner race 154 and a rotatable outer race 156 with at least one bearing element 158 positioned between the stationary inner race 154 and the rotatable outer race 156. The second bearing assembly 162 includes a stationary inner race 164 and a rotatable outer race 166 with at least one bearing element 168 positioned between the stationary inner race 164 and the rotatable outer race 166.

The anode target 52 is sealed within the vacuum chamber 230 of the vacuum vessel frame 228 by a first ferrofluidic seal 238 coupled to the second end 64 of the bearing assembly housing 56 and a second ferrofluidic seal 240 coupled to the open end member 234.

During operation of the x-ray tube, the vacuum vessel frame 228 and the shaft 236 are stationary, while the bearing assembly housing 56, open end member 234 and anode target 52 rotate around the stationary shaft 236.

The anode assembly 232 further includes a gap 242 formed between the stationary shaft 236 and the bearing assembly housing 56, and the open end member 234 extending through the at least one bearing assembly 150. The gap 242 provides a path 244 as shown by arrows 246 for a liquid coolant and lubricant to flow. The liquid coolant and lubricant enters the anode assembly 232 through an inlet 248 in the gap 242 between the shaft 236 and the open end member 234, flows through the at least one bearing assembly 150 and exits through an outlet 250 in the gap 242 between the shaft 236 and the second end 64 of the bearing assembly housing 56 to cool the anode target 52 and lubricate and cool the at least one bearing assembly 150. In an exemplary embodiment, the inlet 248 and the outlet 250 are at opposite ends of the x-ray tube insert 224.

In an exemplary embodiment, the liquid coolant and lubricant may be circulated through the gap 242 by a pump (not shown). In an exemplary embodiment, the inlet 248 and the outlet 250 may be coupled to a reservoir of liquid coolant and lubricant and coupled to the pump for circulating the liquid coolant and lubricant through the flow path 244.

In an exemplary embodiment, the first and second bearing assemblies 152, 162 may be tapped roller bearings or needle bearings.

In an exemplary embodiment, the flow path 244 direction of the liquid coolant and lubricant as indicated by arrows 246 in FIG. 6 may be reversed.

In an exemplary embodiment, the anode target 52 may be hollow, allowing the liquid coolant and lubricant to flow through the anode target 52.

This x-ray tube insert design allows the anode target to handle much higher heat and power without having to change the anode target material. Hence this design provides a higher power anode target without the use of new anode target materials.

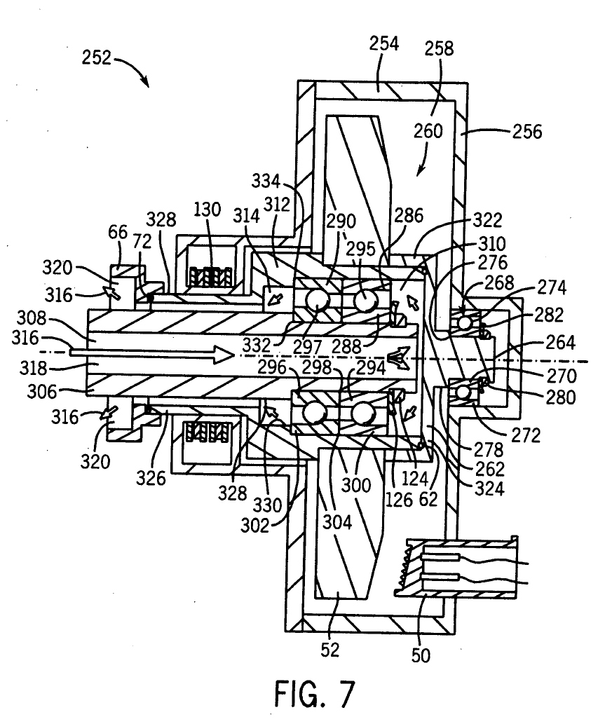

FIG. 7 illustrates a cross-sectional schematic diagram of an exemplary embodiment of an x-ray tube insert 252. The x-ray tube insert 252 includes at least one vacuum vessel 254 having a frame 256 and forming a substantially evacuated vacuum chamber 258 therein. The at least one vacuum vessel 254 is constructed to endure very high temperatures and includes an anode assembly 260 and a cathode assembly 50, which are at least partially disposed therein. The anode assembly 260 includes a rotatable anode target 52 mounted to a first end 322 of a rotatable bearing assembly housing 312. The anode assembly 260 also includes an end cap 262 coupled around the first end 322 of the bearing assembly housing 312 forming a closed end 324 thereof. In an exemplary embodiment, the end cap 262 may be a bolted, brazed, screwed, soldered, welded, or otherwise mechanically attached to the first end 322 of the bearing assembly housing 312. In an exemplary embodiment, a first sealing element 62 hermetically seals the end cap 262 to the first end 322 of the bearing assembly housing 312. A second end 326, opposite the first end 322, of the rotatable bearing assembly housing 312 is coupled to a drive assembly 66 for rotating the rotatable bearing assembly housing 312 and in turn rotating the rotatable anode target 52 at a very high angular velocity. The rotatable bearing assembly housing 312 and anode target 52 attached thereto rotate around a stationary shaft 306 through the use of at least one bearing assembly 286 surrounding the stationary shaft 306. In an exemplary embodiment, a second sealing element 72 hermetically seals the second end 326 of the rotatable bearing assembly housing 312 to the drive assembly 66.

The end cap 262 includes a cantilevered shaft 264 extending outwardly from the closed end 324 thereof towards the vacuum vessel frame 256. At least one bearing assembly 268 is coupled between the end of the cantilevered shaft 264 and the vacuum vessel frame 256 to support the cantilevered shaft 264 and prevent shaft deflection. The at least one bearing assembly 268 includes a stationary inner race 270 and a rotatable outer race 272 with at least one bearing element 274 positioned between the stationary inner race 270 and the rotatable outer race 272. In an exemplary embodiment, the at least one bearing assembly 268 may be a solid lubricated bearing assembly. In an exemplary embodiment, the at least one bearing assembly 268 may be a tapped roller bearing or a needle bearing.

In an exemplary embodiment, a groove 276 may be formed in an outer surface 278 of the cantilevered shaft 264 to hold the at least one bearing assembly 268 therein.

A fastener 280 may be located at the end of the cantilevered shaft 264 and positioned against the at least one bearing assembly 268 to hold the at least one bearing assembly 268 in place. In an exemplary embodiment, a washer 282 may be positioned between the at least one bearing assembly 268 and the fastener 280. In an exemplary embodiment, the fastener 280 may be a bolted, brazed, screwed, soldered, welded, or otherwise mechanically attached to the end of the cantilevered shaft 264.

In an exemplary embodiment, at least one bearing assembly 286 is positioned between an outer surface 328 of the stationary shaft 306 and an inner surface 330 of the bearing assembly housing 312. In an exemplary embodiment, a first groove 332 may be formed in the outer surface 328 of the shaft 306 near the first end 322 and a corresponding second groove 334 may be formed in the inner surface 330 of the bearing assembly housing 312 to hold the at least one bearing assembly 286 therein. A fastener 124 may be located at the end of the shaft 306 and positioned against the at least one bearing assembly 286 to hold the at least one bearing assembly 286 in place. In an exemplary embodiment, a washer 126 may be positioned between the at least one bearing assembly 286 and the fastener 124. In an exemplary embodiment, the fastener 124 may be a bolted, brazed, screwed, soldered, welded, or otherwise mechanically attached to the end of the shaft 306.

In an exemplary embodiment, the at least one bearing assembly 286 is a duplex bearing assembly. The at least one bearing assembly 286 includes a stationary inner race 288 and a rotatable outer race 290 with at least one bearing element 292 positioned between the stationary inner race 288 and the rotatable outer race 290. Although the stationary inner race 288 and the rotatable outer race 290 are shown in FIG. 7 as multi-race elements, the stationary inner race 288 and the rotatable outer race 290 may be formed as single race elements.

The stationary inner race 288 is positioned adjacent to the outer surface 328 of the stationary shaft 306. The inner race 288 is comprised of a first inner race element 294 and a second inner race element 296. These two inner race elements 294, 296 preferably do not contact each other such that an axial gap 298 is formed therebetween. The rotatable outer race 290 is positioned adjacent to the inner surface 330 of the bearing assembly housing 312. The outer race 290 is comprised of a first outer race element 300 and a second outer race element 302. These two outer race elements 300, 302 preferably do not contact each other such that an axial gap 304 is formed therebetween. A first at least one bearing element 295 is positioned between the first inner race element 294 and the first outer race element 300. A second at least one bearing element 297 is positioned between the second inner race element 296 and the second outer race element 302.

During operation of the x-ray tube, the vacuum vessel frame 256 and the shaft 306 are stationary, while the bearing assembly housing 312, end cap 262 and anode target 52 rotate around the stationary shaft 306.

The anode target 52 is sealed within the vacuum chamber 258 of the vacuum vessel frame 256 by a ferrofluidic seal 130. The ferrofluidic seal 130 is positioned outside of the vacuum chamber 258 between the vacuum vessel frame 256 and the bearing assembly housing 312 to seal the anode assembly 260 within the vacuum chamber 258. The ferrofluidic seal 130 encircles the bearing assembly housing 312 forming a hermetic seal around the bearing assembly housing 312 to maintain a vacuum within the vacuum chamber 258. The ferrofluidic seal 130 serves as a barrier to the passage of gas along an outer surface 328 of the bearing assembly housing 312 at the second end 326 thereof, while at the same time permitting rotation of the bearing assembly housing 312 as desired.

The stationary shaft 306 includes at least one opening 308 extending therethrough creating a hollow shaft. In addition, a gap 310 is formed between the stationary shaft 306, end cap 262 and bearing assembly housing 312 extending through the at least one bearing assembly 268. The at least one opening 308 and gap 310 provides a path 314 as shown by arrows 316 for a liquid coolant and lubricant to flow. The liquid coolant and lubricant enters the anode assembly 260 through an inlet 318 in the opening 308 extending through shaft 306, flows around the outside of the shaft 306 and inside of the bearing assembly housing 312 through the at least one bearing assembly 268, and exits through an outlet 320 in the gap 310 between the shaft 306 and the bearing assembly housing 312 to cool the anode target 52 and lubricate and cool the at least one bearing assembly 268. In an exemplary embodiment, the liquid coolant and lubricant may be circulated through the at least one opening 308 and gap 310 between the shaft 306 and the bearing assembly housing 312 through the at least one bearing assembly 268 by a pump (not shown). In an exemplary embodiment, the inlet 318 and the outlet 320 may be coupled to a reservoir of liquid coolant and lubricant and coupled to the pump for circulating the liquid coolant and lubricant through the flow path 314.

The liquid coolant and lubricant functions both as a coolant for cooling the anode target 52 and as a lubricant and coolant for lubricating and cooling the at least one bearing assembly 268. In an exemplary embodiment, the liquid coolant and lubricant may be a dielectric oil. In an exemplary embodiment, the liquid coolant and lubricant may be a bearing oil lubricant, such as a mineral oil or a synthetic oil.

In an exemplary embodiment, the flow path 314 direction of the liquid coolant and lubricant as indicated by arrows 316 in FIG. 7 may be reversed.

In an exemplary embodiment, the anode target 52 may be hollow, allowing the liquid coolant and lubricant to flow through the anode target 52.

This x-ray tube insert design allows the anode target to handle much higher heat and power without having to change the anode target material. Hence this design provides a higher power anode target without the use of new anode target materials.

Several embodiments are described above with reference to drawings. These drawings illustrate certain details of exemplary embodiments that implement the apparatus, assemblies, systems, and methods of this disclosure. However, the drawings should not be construed as imposing any limitations associated with features shown in the drawings.

In various embodiments, an anode assembly for an x-ray tube is described. However, the embodiments are not limited and may be implemented in connection with different applications. The application of the disclosure can be extended to other areas both industrial and medical, for example medical imaging; diagnostic and therapeutic radiology; semiconductor manufacture and fabrication; material analysis and testing; industrial inspection; security scanning; and particle accelerators, etc.

While the disclosure has been described with reference to various embodiments, those skilled in the art will appreciate that certain substitutions, alterations and omissions may be made to the embodiments without departing from the spirit of the disclosure. Accordingly, the foregoing description is meant to be exemplary only, and should not limit the scope of the disclosure as set forth in the following claims.

What is claimed is:

1. An x-ray tube comprising:
a liquid cooled anode target; and
a liquid lubricated bearing assembly.

2. The x-ray tube of claim 1, further comprising a liquid coolant and lubricant circulating through an opening extending through a shaft coupled to the bearing assembly, a gap formed between the shaft and a bearing assembly housing coupled to the anode target, and through the bearing assembly to cool the anode target and lubricate the bearing assembly.

3. The x-ray tube of claim 2, wherein the shaft is stationary, and the bearing assembly housing and the anode target are rotatable around the shaft.

4. The x-ray tube of claim 2, wherein the liquid coolant and lubricant is a dielectric oil.

5. The x-ray tube of claim 2, wherein the liquid coolant and lubricant is a mineral oil.

6. The x-ray tube of claim 2, wherein the liquid coolant and lubricant is a synthetic oil.

7. An x-ray tube comprising:
at least one vacuum vessel forming a substantially evacuated vacuum chamber;
an anode assembly disposed at least partially within the vacuum chamber;
a cathode assembly disposed at least partially within the vacuum chamber and spaced apart from the anode assembly;
the anode assembly comprising:
a rotatable anode target mounted to a rotatable bearing assembly housing;
an end cap coupled around a first end of the rotatable bearing assembly housing, the end cap forming a closed end at the first end of the rotatable bearing assembly housing;
a stationary shaft; and
at least one bearing assembly coupled between an outer surface of the stationary shaft and an inner surface of the rotatable bearing assembly housing;
at least one ferrofluidic seal coupled to an outer surface on a second end of the rotatable bearing assembly housing for sealing the rotatable bearing assembly housing within the vacuum chamber;
at least one opening extending through the stationary shaft;
a gap formed between the outer surface of the stationary shaft and the inner surface of the rotatable bearing assembly housing; and
a flow path for circulating a liquid coolant and lubricant through the at least one opening, the gap, and the at least one bearing assembly.

8. The x-ray tube of claim 7, wherein the liquid coolant and lubricant enters the anode assembly through the at least one opening extending through the stationary shaft, flows around the outer surface of the stationary shaft and the inner surface of the rotatable bearing assembly housing through the at least one bearing assembly, and exits the anode assembly through the gap at the second end of the rotatable bearing assembly housing to cool the rotatable anode target and lubricate the at least one bearing assembly.

9. The x-ray tube of claim 7, wherein the liquid coolant and lubricant is a dielectric oil.

10. The x-ray tube of claim 7, wherein the liquid coolant and lubricant is a mineral oil.

11. The x-ray tube of claim 7, wherein the liquid coolant and lubricant is a synthetic oil.

12. The x-ray tube of claim 7, wherein the at least one bearing assembly includes duplex bearings.

13. The x-ray tube of claim 7, wherein the at least one bearing assembly includes angular contact bearings.

14. The x-ray tube of claim 7, wherein the at least one bearing assembly includes tapped roller bearings.

15. The x-ray tube of claim 7, wherein the at least one bearing assembly includes needle bearings.

16. An x-ray tube anode assembly comprising:
a stationary shaft;
at least one bearing assembly coupled around the stationary shaft;
a rotatable bearing assembly housing coupled around the at least one bearing assembly;
a rotatable anode target mounted to the rotatable bearing assembly housing;
an end cap coupled around a first end of the bearing assembly housing forming a closed end thereof;
a second end of the rotatable bearing assembly housing coupled to a drive assembly for rotating the rotatable bearing assembly housing and the rotatable anode target;
at least one ferrofluidic seal coupled to the second end of the rotatable bearing assembly housing;
at least one opening extending through the stationary shaft;
a gap formed between the stationary shaft, the end cap and the rotatable bearing assembly housing;
a flow path for circulating a liquid coolant and lubricant through the at least one opening, the gap, and the at least one bearing assembly.

17. The x-ray tube anode assembly of claim 16, wherein the liquid coolant and lubricant enters the at least one opening extending through the stationary shaft, flows around an outer surface of the stationary shaft and an inner surface of the rotatable bearing assembly housing through the at least one bearing assembly, and exits through the gap at the second end of the rotatable bearing assembly housing to cool the rotatable anode target and lubricate the at least one bearing assembly.

18. The x-ray tube anode assembly of claim 16, further comprising a nozzle coupled to the at least one opening extending through the stationary shaft for spraying the liquid coolant and lubricant at the rotatable anode target.

19. An x-ray tube anode assembly comprising:
a stationary shaft;
at least one bearing assembly coupled around the stationary shaft;
a rotatable bearing assembly housing coupled around the at least one bearing assembly;
a rotatable anode target mounted to the rotatable bearing assembly housing;
an open end member coupled around a first end of the bearing assembly housing;
a second end of the rotatable bearing assembly housing coupled to a drive assembly for rotating the rotatable bearing assembly housing, the rotatable anode target, and the open end member;
a first ferrofluidic seal coupled to the second end of the rotatable bearing assembly housing;
a second ferrofluidic seal coupled to the open end member;
a gap formed between the stationary shaft and the rotatable bearing assembly housing and the open end member;
a flow path for circulating a liquid coolant and lubricant through the gap and the at least one bearing assembly.

20. The x-ray tube anode assembly of claim 19, wherein the liquid coolant and lubricant enters the gap at the open end member, flows around an outer surface of the stationary shaft and an inner surface of the open end member and rotatable bearing assembly housing through the at least one bearing assembly, and exits through the gap at the second end of the rotatable bearing assembly housing to cool the rotatable anode target and lubricate the at least one bearing assembly.
